(19) United States
(12) Patent Application Publication
(10) Pub. No.: US 2024/0202633 A1
(43) Pub. Date: Jun. 20, 2024

(54) System and Related Methods for Monitoring Performance of a Physical Activity

(71) Applicants: Isura Ranatunga, Concord, CA (US); Channa Ranatunga, Grand Prairie, TX (US); Sandeep Suresh, Emeryville, CA (US)

(72) Inventors: Isura Ranatunga, Concord, CA (US); Channa Ranatunga, Grand Prairie, TX (US); Sandeep Suresh, Emeryville, CA (US)

(21) Appl. No.: 18/082,607

(22) Filed: Dec. 16, 2022

(51) Int. Cl. G06Q 10/0639; G06T 7/10; G06V 30/148

(52) U.S. Cl. CPC G06Q 10/0639; G06T 7/10; G06V 30/153

(57) ABSTRACT

The present disclosure provides a system and related methods for monitoring the performance of a physical activity such as a packaging operation in a warehouse. The system comprises a database for storing order information and one or more workstations each equipped with an image sensor, a display, and a local controller. Requirements for the physical activity and its performance are monitored, with performance metrics being generated in real-time and used to update a set of instructions on the display. After the activity has ended, a report associated with an order ID and containing portions of the recorded data and the performance metrics is sent to the database, and is viewable via an online platform hosted by one or more servers. This greatly improves the reliability and ease of quality assurance and generates intuitive insights that can be used for process improvement.

### FIELD OF INVENTION

The present invention relates generally to performance monitoring systems. More specifically, the present disclosure relates to a system capable of monitoring a physical activity while analyzing performance metrics in real-time.

### BACKGROUND

With the increasing reliance on online commerce and direct-to-consumer deliveries, there has been a drive to expand warehouse order fulfillment and packaging operations on a huge scale. While many organizations have found ways to do so, the increase in scale puts huge pressure on the efficiency and accuracy of the warehouse processes. This includes increases in the burden of Quality Assurance checks that need to be in place to ensure appropriate standards of care, address consumer complaints, and to provide transparency and accountability when errors are made.

In current practices, organizations spend large amounts of effort and operational costs on manual Quality Assurance. The processes usually involve a great deal of tedious manual data entry that is also subject to human error. For example, some packaging warehouse QA processes involve randomly selecting and opening packed orders and checking the contents against a bill of materials, evaluating the dunnage, and then repackaging them and sending them out.

These methods do give some insights into overall quality of packaging accuracy, but they lack evidence of what actually occurred during the packaging process for checked orders, and thus fail to give insights into how and why errors may have occurred. Much of the time spent on these checks is used in simply identifying that an error in the fulfilment process happened at all. Furthermore, since data is only reported after each check, the feedback is only able to be used reactively. There is no ability to identify errors and proactively address them to improve processes in real-time.

A scalable solution is needed to monitor and assess the performance of these processes to identify issues as they occur and generate evidenced insights so that organizations can proactively improve their operations. It is within this context that the present invention is provided.

### SUMMARY

The present disclosure provides a system and related methods for monitoring the performance of a physical activity such as a packaging operation in a warehouse. The system comprises a database for storing order information and one or more workstations each equipped with an image sensor, a display, and a local controller. Requirements for the physical activity and its performance are monitored, with performance metrics being generated in real-time and used to update a set of instructions on the display. After the activity has ended, a report associated with an order ID and containing portions of the recorded data and the performance metrics is sent to the database, and is viewable via an online platform hosted by one or more servers. This greatly improves the reliability and ease of quality assurance and generates intuitive insights that can be used for process improvement.

According to a first aspect of the present disclosure, there is provided a system for monitoring performance of a physical activity, the system comprising: one or more networked user devices; a database, the database having stored thereon order data for a plurality of orders each having an associated ID; one or more workstations, each workstation comprising: at least one image sensor; a display; and a local controller in communication with the database.

Each local controller is configured to: receive an order ID; determine one or more requirements for a physical activity associated with the order ID based on the order data associated with the order ID; indicate the one or more requirements on the display via a UI; receive sensor data from the at least one image sensor; analyse the image data using object detection and segmentation algorithms in real-time to determine which of the one or more requirements associated with the order ID have been fulfilled; generate one or more performance metrics for the physical activity based on the analysis; update the UI on the display in response to each determination of a fulfilled requirement; determine that the physical activity associated with the order ID has ended; and compile and send to the database a report to be associated with the order ID, the report comprising at least a portion of the captured image data, a record of the UI indication, and the one or more performance metrics.

The system further comprises one or more servers in communication with the database and the one or more user devices, the one or more servers being configured to host an online platform on which the user devices may access and view order data and reports associated with each order ID stored on the database for which they have viewing permissions.

In some embodiments, each workstation further comprises one or more secondary sensors connected to the local controller, each secondary sensor being configured to determine information about an object associated with the order ID.

The secondary sensors may include a barcode scanner for determining the order ID from a package label and/or a weighing scale for determining a weight of one or more items associated with the order ID.

In some embodiments, each local controller is further configured to operate one or more periphery devices of the workstation based on the real-time analysis of the image data.

The one or more periphery devices may include, for example, one or more of: a tape dispenser, a label printer, a dunnage dispenser, and one or more lighting elements.

In some embodiments, the physical activity is a warehouse packing process.

In some embodiments, the performance metrics generated include one or more of: a breakdown of time usage, an error rate, a rate of order processing.

In some embodiments, the one or more image sensors include a three-dimensional camera function, and wherein the local controller of each workstation is further configured to determine one or more dimensions of an item based on the received image data.

In some embodiments, each local controller is configured to intelligently determine which portions of the image data to record based on the real-time analysis. The determination may further comprise the steps of: determining one or more conditions associated with the physical activity; determining that one or more of the conditions have not been met; and recording a portion of the image data during which the conditions were not met.

In some embodiments, each local controller is further configured to, in response to a determination that a condition has not been met, generate an alert or warning message on the UI display.

In some embodiments, the at least one image sensor is further configured to operate as a barcode scanner.

In some embodiments, the at least one image sensor is further configured to generate order data for the order ID via optical character recognition of package labels.

In some embodiments, the one or more servers and/or one or more of the local controllers are configured to interface with one or more third party applications via an application programming interface.

### BRIEF DESCRIPTION OF THE DRAWINGS

Various embodiments of the invention are disclosed in the following detailed description and accompanying drawings.

FIG. 1 illustrates an example system architecture for implementing the operations disclosed herein.

FIG. 2A illustrates an initial state of an example User Interface (UI) display at the start of an order fulfilment operation that is part of the disclosed system.

FIG. 2B illustrates a success state of the example UI display after the completion of an order fulfilment operation with no errors having occurred.

FIG. 2C illustrates an error state of the example UI display after the completion of an order fulfilment operation where a requirement was detected as not being fulfilled.

FIG. 3 illustrates another example system architecture for a workstation of the disclosed system with a number of peripheral devices incorporated.

FIG. 4 illustrates an example UI interface for viewing analytics generated in relation to an order fulfillment operation.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The terms “about” and “approximately” shall generally mean an acceptable degree of error or variation for the quantity measured given the nature or precision of the measurements. Typical, exemplary degrees of error or variation are within 20 percent (%), preferably within 10%, and more preferably within 5% of a given value or range of values. Numerical quantities given in this description are approximate unless stated otherwise, meaning that the term “about” or “approximately” can be inferred when not expressly stated.

It will be understood that when a feature or element is referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments.

The terminology used herein is for the purpose of describing particular embodiments only and is not intended to be limiting. As used herein, the singular forms “a,” “an” and “the” are intended to include the plural forms as well, unless the context clearly indicates otherwise.

The terms “first,” “second,” and the like are used herein to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present disclosure.

The present disclosure provides a performance monitoring system, the operations of which facilitate instant visibility into packing and order fulfilment operations in a warehouse, which in turn allows organizations to correct errors before they become costly to fix and/or reach the end user. The system is able to accurately and quickly measure baseline performance on the fulfillment floor to drive better performance and design more streamlined protocols at scale.

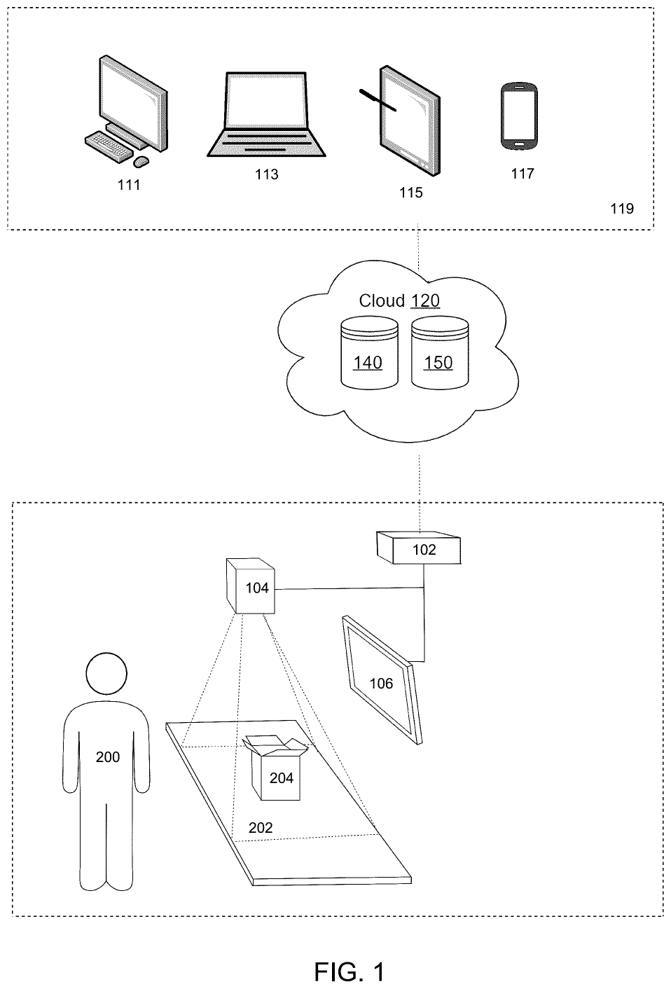

Referring to FIG. 1, an example system architecture for implementing the operations disclosed herein.

The architecture includes a set of user devices 119, a cloud network architecture 120 with a database 140 and server 150, and a packing station (bottom dashed box) which includes a local controller 102 in communication with the cloud, an image sensor 104 configured to monitor the activities of a user 200 in a workspace 200, and a UI display 106 viewable by the user 200. In reality, the system will include a large number of connected workstations which will communicate with and upload data, including generated analytics and recorded sensor data, to the cloud 120.

Exemplary user devices 119 as may be used in the Performance Monitoring System include, without limitation, a personal computer (PC) 111, a laptop 113, a tablet computer 115, and smartphone 117. Generally, each user device 119 includes a display and/or one or more processors. The display 115 offers the user a visual interface for interaction with the Performance Monitoring System. For example, the Performance Monitoring System may be presented in a dedicated application or “App” platform with a custom interface that makes use of known techniques for user interaction. The platform may also be accessed via a standard web browser in some examples.

Generally, each user device 119 is in communication with network 120 through a communications channel. The network 120 is also in communication with server 140 and may further communicate with a database 150.

The server 140 contains instruction sets governing platform operations. The database 150 contains data on all orders being handled by the system, including uploaded data, order IDs, and any other information acquired by interfacing with third parties through Applications Programming Interfaces. The database 150 may also contain user account information, history, etc. The foregoing are merely illustrative of the architecture of the Performance Monitoring System and is not meant to be limiting.

The local controller 102 of each workstation is configured to receive order IDs, either by visual identification at the work station (OCR scanners of packaging labels, barcodes scanners, etc.) or via communication with cloud 120. The order ID will have associated order data in the database 150 such as the contents to be packaged, the type and amount of dunnage needed, etc. The local controller 102 can thus determine packaging requirements for the packaging process and display them on the UI display 106.

As the worker fulfills the order, image data is received by the local controller 102 from the image sensor 104, which is analyzed in real time to determine if the user is packaging the contents of the order appropriately—have they missed any items? Have they include appropriate dunnage? Have they added the correct label? The UI display 106 is updated at each step, and can display error or step success completion as the work is in progress.

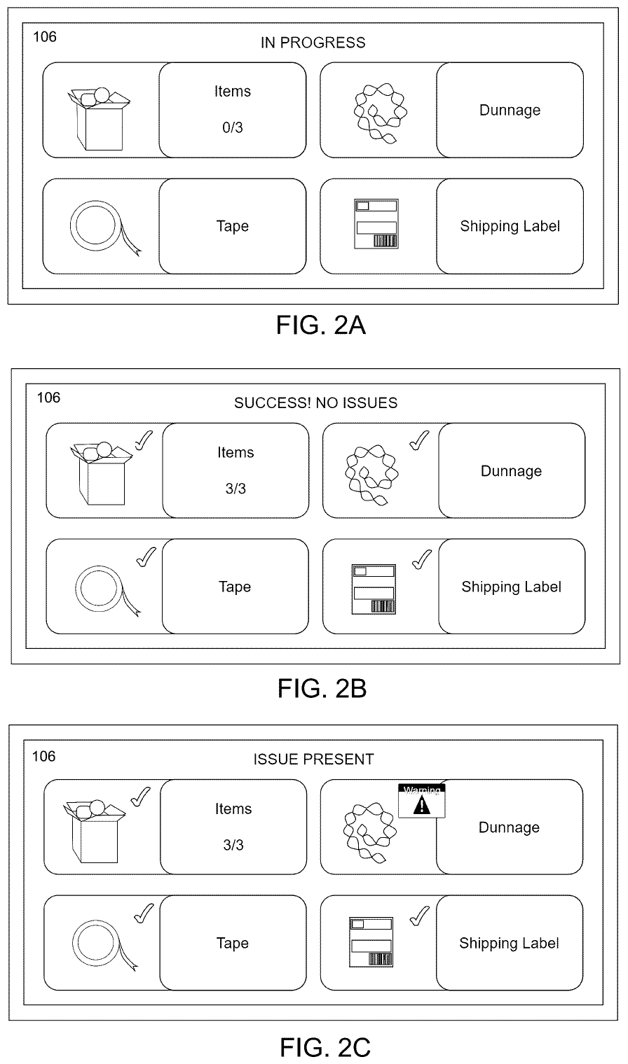

Referring to FIG. 2A-FIG. 2C, a set of example User Interface (UI) displays 106 are shown for, respectively, the start of an order fulfilment operation, a successful order fulfilment operation, and an order fulfilment operation where an error was detected.

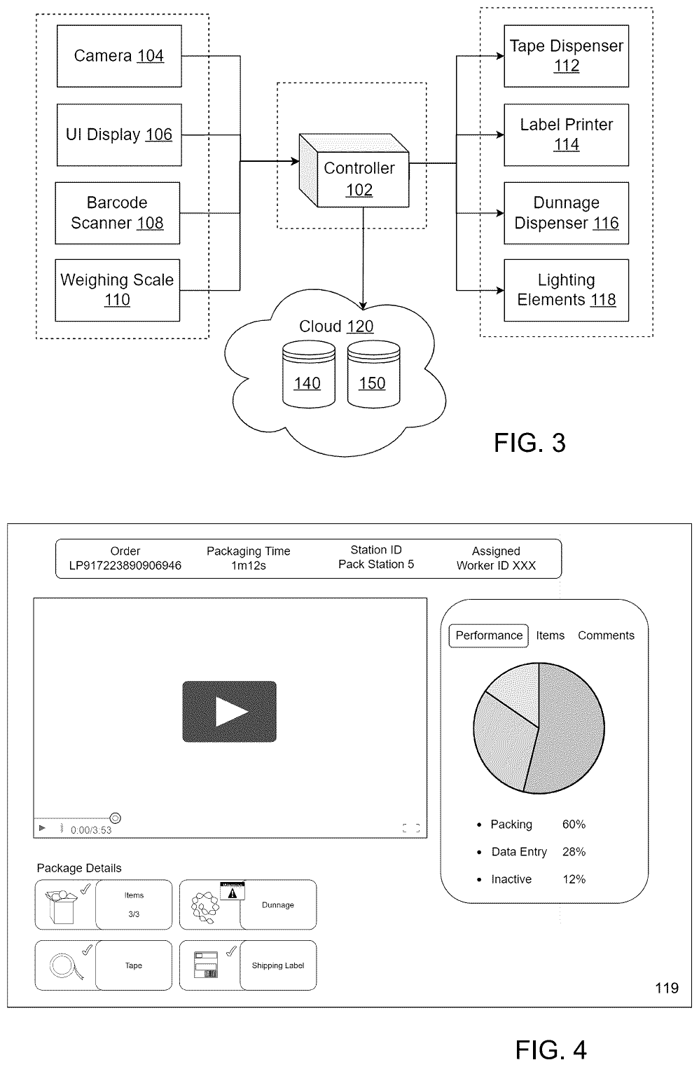

As can be seen, the number of items packaged is tracked in real time (0/3 in FIG. 2A and 3/3 in FIG. 2B and FIG. 2C), as are the steps which have been completed successfully by the packer, which show a tick once they have been completed.

The local controller 102 identifies from the image data provided when a step has not been completed, or when it has been completed incorrectly, and displays an error message as shown in the dunnage section of FIG. 2C. This can both be used to help packers correct errors early and as evidence and to gain insights, as the UI display is screen recorded and included by the local controller 102 in automatically generated reports that are sent to the cloud 120 and stored in database 150.

The reports also include sections of captured image data, recorded intelligently in response to visual triggers and UI events such as completion of packing steps. The analysis is performed using object identification, segmentation, and machine learning algorithms. The local controller 102 may also generate performance metrics in real-time, such as a breakdown of time spent performing certain activities by the packer, average time spent per order ID, etc.

Referring to FIG. 3 another example system architecture is shown for a workstation of the disclosed system with a number of peripheral devices incorporated and in communication with the local controller 102.

Since the controller 102 is monitoring and analyzing the packing/order fulfilment process in real-time, it can work in conjunction with a number of connected peripheral devices at the workstation to increase packing efficiency.

This includes any number of secondary sensors for determining various information about the subject of the order being fulfilled, such as a barcode scanner 108 for determining the order ID from a package label and/or a weighing scale 110 for determining a weight of one or more items associated with the order ID. The work station may also include a three-dimensional camera function, either integrated with image sensor 104 or in addition to it, for determining one or more dimensions of a package item based on the received image data.

The controller 102 can also instruct one or more periphery devices based on the stage of packing it determines has been reached based on the image data from camera 104. In the present example, these include a tape dispenser 112, a label printer 114, a dunnage dispenser 116, and one or more lighting elements 118.

Finally, referring to FIG. 4, an example UI interface is shown for viewing analytics generated in relation to an order fulfillment operation by a local controller. This UI would be viewable through the performance monitoring platform described above, and a page as shown would be viewable for each order processed at a workstation. As can be seen, various data and insights are shown that relate to that order ID, including a breakdown of the packer's activity during the fulfilment process, a video of at least a portion of the image data captured by the image sensor, and the metrics of the UI display that were determined during the fulfilment process.

The metrics can be used by Quality Assurance professionals and customer relations teams to quickly identify and assess whether an error was made with the order and what kind of error it was. The video can be used as evidence in the event of customer disputes and can be reviewed prior to authorizing refunds, for example.

With access to such data being automatically available for each order processed through the system, there is no need for manual data entry or Quality Assurance checks, since they can be performed remotely and can glean effective insights even after orders have been processed.

Overall, the system facilitates comprehensive visibility into packaging and order fulfilment processes, which in turn leads to near-instant troubleshooting and process improvement.

Implementation of the system can foster better communications and greater collaboration between operational management and client engagement teams.

A controller can be any suitable type of computer. A computer may be a uniprocessor or multiprocessor machine. Accordingly, a computer may include one or more processors and, thus, the aforementioned computer system may also include one or more processors. Examples of processors include sequential state machines, microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), gated logic, programmable control boards (PCBs), and other suitable hardware configured to perform the various functionality described throughout this disclosure.

Additionally, the computer may include one or more memories. Accordingly, the aforementioned computer systems may include one or more memories. A memory may include a memory storage device or an addressable storage medium which may include, by way of example, random access memory (RAM), static random access memory (SRAM), dynamic random access memory (DRAM), electronically erasable programmable read-only memory (EEPROM), programmable read-only memory (PROM), erasable programmable read-only memory (EPROM), hard disks, floppy disks, laser disk players, digital video disks, compact disks, video tapes, audio tapes, magnetic recording tracks, magnetic tunnel junction (MTJ) memory, optical memory storage, quantum mechanical storage, electronic networks, and/or other devices or technologies used to store electronic content such as programs and data. In particular, the one or more memories may store computer executable instructions that, when executed by the one or more processors, cause the one or more processors to implement the procedures and techniques described herein. The one or more processors may be operably associated with the one or more memories so that the computer executable instructions can be provided to the one or more processors for execution. For example, the one or more processors may be operably associated to the one or more memories through one or more buses. Furthermore, the computer may possess or may be operably associated with input devices (e.g., a keyboard, a keypad, controller, a mouse, a microphone, a touch screen, a sensor) and output devices such as (e.g., a computer screen, printer, or a speaker).

The computer may execute an appropriate operating system such as LINUX®, UNIX®, MICROSOFT® WINDOWS®, APPLE® MACOS®, IBM® OS/2®, Digital Multiplex Signal DMX 512, CHROME® OS, ANDROID, and PALM® OS, and/or the like. The computer may advantageously be equipped with a network communication device such as a network interface card, a modem, or other network connection device suitable for connecting to one or more networks.

A computer may advantageously contain control logic, or program logic, or other substrate configuration representing data and instructions, which cause the computer to operate in a specific and predefined manner as, described herein. In particular, the computer programs, when executed, enable a control processor to perform and/or cause the performance of features of the present disclosure. The control logic may advantageously be implemented as one or more modules. The modules may advantageously be configured to reside on the computer memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro code, circuitry, data, and/or the like.

The control logic conventionally includes the manipulation of digital bits by the processor and the maintenance of these bits within memory storage devices resident in one or more of the memory storage devices. Such memory storage devices may impose a physical organization upon the collection of stored data bits, which are generally stored by specific electrical or magnetic storage cells.

The control logic generally performs a sequence of computer-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, files, or the like. It should be kept in mind, however, that these and some other terms should be associated with appropriate physical quantities for computer operations, and that these terms are merely conventional labels applied to physical quantities that exist within and during operation of the computer based on designed relationships between these physical quantities and the symbolic values they represent.

It should be understood that manipulations within the computer are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the computer or computers.

It should also be understood that the programs, modules, processes, methods, and the like, described herein are but an exemplary implementation and are not related, or limited, to any particular computer, apparatus, or computer language. Rather, various types of general purpose computing machines or devices may be used with programs constructed in accordance with some of the teachings described herein. In some embodiments, very specific computing machines, with specific functionality, may be required. Similarly, it may prove advantageous to construct a specialized apparatus to perform the method steps described herein by way of dedicated computer systems with hard-wired logic or programs stored in nonvolatile memory, such as, by way of example, read-only memory (ROM).

In some embodiments, features of the computer systems can be implemented primarily in hardware using, for example, hardware components such as application specific integrated circuits (ASICs) or field-programmable gated arrays (FPGAs). Implementation of the hardware circuitry will be apparent to persons skilled in the relevant art(s). In yet another embodiment, features of the computer systems can be implemented using a combination of both general-purpose hardware and software

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the system and method have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A system for monitoring performance of a physical activity, the system comprising:
one or more networked user devices;
a database, the database having stored thereon order data for a plurality of orders each having an associated ID;
one or more workstations, each workstation comprising:
at least one image sensor;
a display;
a local controller in communication with the database, the local controller being configured to:
receive an order ID;
determine one or more requirements for a physical activity associated with the order ID based on the order data associated with the order ID;
indicate the one or more requirements on the display via a UI;
receive sensor data from the at least one image sensor;
analyse the image data using object detection and segmentation algorithms in real-time to determine which of the one or more requirements associated with the order ID have been fulfilled;
generate one or more performance metrics for the physical activity based on the analysis;
update the UI on the display in response to each determination of a fulfilled requirement;
determine that the physical activity associated with the order ID has ended; and
compile and send to the database a report to be associated with the order ID, the report comprising at least a portion of the captured image data, a record of the UI indication, and the one or more performance metrics;
one or more servers in communication with the database and the one or more user devices, the one or more servers being configured to host an online platform on which the user devices may access and view order data and reports associated with each order ID stored on the database for which they have viewing permissions.

2. A system according to claim 1, wherein each workstation further comprises one or more secondary sensors connected to the local controller, each secondary sensor being configured to determine information about an object associated with the order ID.

3. A system according to claim 2, wherein the secondary sensors include a barcode scanner for determining the order ID from a package label.

4. A system according to claim 2, wherein the secondary sensors include a weighing scale for determining a weight of one or more items associated with the order ID.

5. A system according to claim 1, wherein each local controller is further configured to operate one or more periphery devices of the workstation based on the real-time analysis of the image data.

6. A system according to claim 5, wherein the one or more periphery devices include one or more of: a tape dispenser, a label printer, a dunnage dispenser, and one or more lighting elements.

7. A system according to claim 1, wherein the physical activity is a warehouse packing process.

8. A system according to claim 1, wherein the performance metrics generated include one or more of: a breakdown of time usage, an error rate, a rate of order processing.

9. A system according to claim 1, wherein the one or more image sensors include a three-dimensional camera function, and wherein the local controller of each workstation is further configured to determine one or more dimensions of an item based on the received image data.

10. A system according to claim 1, wherein each local controller is configured to intelligently determine which portions of the image data to record based on the real-time analysis.

11. A system according to claim 10, wherein the determination further comprises the steps of: determining one or more conditions associated with the physical activity; determining that one or more of the conditions have not been met; and recording a portion of the image data during which the conditions were not met.

12. A system according to claim 1, wherein each local controller is further configured to, in response to a determination that a condition has not been met, generate an alert or warning message on the UI display.

13. A system according to claim 1, wherein the at least one image sensor is further configured to operate as a barcode scanner.

14. A system according to claim 1, wherein the at least one image sensor is further configured to generate order data for the order ID via optical character recognition of package labels.

15. A system according to claim 1, wherein the one or more servers and/or one or more of the local controllers are configured to interface with one or more third party applications via an application programming interface.
